(19) United States
(12) Patent Application Publication
(10) Pub. No.: US 2005/0243565 A1
(43) Pub. Date: Nov. 3, 2005

(54) Invisible seasonal light holder

(76) Inventor: Dwight Allen Witherspoon, Newport Beach, CA (US)

Correspondence Address: Barber Legal, PO Box 16220, Golden, CO, 80402-6004, US

(21) Appl. No.: 10/836,556

(22) Filed: Apr. 29, 2004

(51) Int. Cl. F21S 8/00

(52) U.S. Cl. 362/427

(57) ABSTRACT

A home seasonal light carrier may have a mounting dimensioned and configured to as to be mounted on the rear side of a fascia board or other eave structure. The mount may further have the ability to move behind the fascia board into a first position, so that the entire device, lights and all, may be removed from public view while still attached to the house. During the season of lighting display, the lights may be moved downwards into a second position allowing the lights to be visible. Christmas lights or other seasonal lights may be attached to the device's moving light holder by means of a light attachment.

### CROSS-REFERENCE TO RELATED APPLICATIONS

This invention claims the priority and benefit of U.S. Provisional Patent Application 60/466,216 filed Apr. 28, 2003 to the same inventor.

### STATEMENT REGARDING FEDERALLY FUNDED RESEARCH

This invention was not made under contract with an agency of the US Government, nor by any agency of the US Government.

### FIELD OF THE INVENTION

This invention relates generally to lights and illumination and specifically to a permanently mounted holder for selective display of seasonal lights such as Christmas lights.

### BACKGROUND OF THE INVENTION

Mounting Christmas lights or other seasonal lights on houses is a perennial task for many people. The lights must be unearthed from storage, carried up a ladder to the gutter or eaves, secured to the house, and the process repeated in reverse when they are taken down. One time saver is to leave hooks in place for the entire year, thus making one step in the process easier. Another time saver is simply to leave the lights up year round. This last is not only unsightly during the season when the lights are not burned, it is also against local ordinances and covenants in many areas.

As a result, a good deal of ingenuity has gone into finding a device to allow Christmas lights to be kept mounted year round. The devices below have certain important features in common. In particular, all of the following devices are designed to be mounted on the building in a visible location such as above or below the gutter, on the front of the fascia board, on the siding, over a window, etc. Such devices are thus permanently visible on the front of the building: these devices allow the lights to be hidden but are not themselves hidden.

U.S. Pat. No. 6,572,239 issued Jun. 3, 2003 to Harbin is an item with a long rail or box on the house. The lights are in the box, and covers are slid sideways to open or close the box to expose the lights or hide them. U.S. Pat. No. 5,404,279 issued Apr. 4, 1995 to Wood is similar but the cover slides vertically. In both cases, the device mounts to the front of the building.

U.S. Pat. No. 6,474,840 issued Nov. 5, 2002 to Padermos is just the first example of a large number with a common system. These ones all have a box with a hinged cover that can be opened or closed to expose the lights. NOTE that in all of these, the lights are FIXED INSIDE THE BOX, and NOT on the moving part. U.S. Pat. No. 6,363,662 issued Apr. 2, 2002 to Coates is the same, plus being a gutter GUARD. U.S. Pat. No. 6,309,086 issued Oct. 30, 2001 to Tomlinson is another. U.S. Pat. No. 6,224,232 issued May 1, 2001 to Rodriguez has a cover which is generally “V” shaped. U.S. Pat. No. 6,088,967 issued Jul. 18, 2000 to Johnson is also in this broad group, and so is U.S. Pat. No. 6,019,488 issued Feb. 1, 2000 to Hastings. U.S. Pat. No. 5,594,628 issued Jan. 14, 1997 to Reuter et al and U.S. Pat. No. 5,311,414 issued May 10, 1994 to Branham, Sr are more of the “hinged boxes”. All of these devices are to be mounted so as to be themselves visible year round.

U.S. Pat. No. 5,816,687 issued Oct. 6, 1998 to Tapp is the first of the items which actually show the bulbs on the rotating part of the enclosure. It is still an entire box, and the swinging member is not a “V” shape which can hide the bulbs by itself. U.S. Pat. No. 5,510,966 issued Apr. 23, 1996 to Konecny is another of the very relevant items, again with an entire box enclosure and a moving part that isn't “V” shaped and doesn't conceal the bulbs by itself. Neither such device conceals itself either.

U.S. Pat. No. 4,128,863 issued Dec. 5, 1978 to Premetz teaches a device that appears to be hard to make out. U.S. Pat. No. 3,692,993 issued Sep. 19, 1972 to Robinson actually teaches a box enclosure and a swinging “V” section member, but with the lights on the outside of the “V”, not the inside. Thus the “V” does not obscure the lights during the “off season”, instead, the box enclosure does. Again, the enclosure is visible year round.

U.S. Pat. No. 3,569,691 issued Mar. 9, 1971 to Tracy is one last item in which strings or wires on pulleys move the actual light bulbs one at a time.

It would be preferable to provide a device which is not itself another visible feature of the house, yet which allows easy display or hiding of the seasonal lights such as Christmas lights.

### SUMMARY OF THE INVENTION

General Summary

The present invention teaches that a home seasonal light mount may be dimensioned and configured to as to be mounted on the rear side of a fascia board or other eave structure. The mount may further have the ability to move behind the fascia board into a first position, so that the entire device, lights and all, may be removed from public view while still attached to the house. During the season of lighting display, the lights may be moved downwards into a second position allowing the lights to be visible. Christmas lights or other seasonal lights may be attached to the device's moving light holder by means of a light attachment.

Summary in Reference to claims

It is therefore a first aspect, advantage, objective and embodiment of the present invention to provide a seasonal light holder comprising: a mounting dimensioned and configured so as to physically engage with at least a first portion of a home eave not publically substantially visible, a light holder movably attached to the mounting, a seasonal light attachment, the seasonal light attachment dimensioned and configured to physically engage with at least one portion of such seasonal light, the light holder having a first position in which the moving light holder, the mounting, the seasonal light attachment, and such seasonal light attached thereto are not publically substantially visible, and a second position in which such seasonal light is publically substantially visible.

It is therefore another aspect, advantage, objective and embodiment of the present invention to provide a seasonal light carrier wherein the seasonal light attachment is physically attached to one member selected from the group consisting of the light holder, the mounting, the fascia, another part of the house, and combinations thereof.

It is therefore another aspect, advantage, objective and embodiment of the present invention to provide a seasonal light carrier wherein the mounting comprises an arm having a first part secured to the portion of the home eave not publically substantially visible and having a second part at which the movable attachment of the light holder is located.

It is therefore another aspect, advantage, objective and embodiment of the present invention to provide a seasonal light carrier wherein the movable attachment of the light holder to the mounting comprises one member selected from the group consisting of: hinges, pins, axes, slides, rails, runners, and combinations thereof.

It is therefore another aspect, advantage, objective and embodiment of the present invention to provide a seasonal light carrier wherein the light holder further comprises: a longitudinal member having a “V” shaped cross section.

It is therefore another aspect, advantage, objective and embodiment of the present invention to provide a seasonal light carrier wherein the light holder further comprises: at least one such seasonal light physically engaged to the seasonal light attachment.

It is therefore another aspect, advantage, objective and embodiment of the present invention to provide a seasonal light carrier wherein the seasonal light attachment further comprises a “C” ring having a gap therethrough, wherein the gap is dimensioned and configured to accept the wire of a seasonal light.

It is therefore another aspect, advantage, objective and embodiment of the present invention to provide a seasonal light carrier wherein the light holder moves between the first and second positions by rotating.

It is therefore another aspect, advantage, objective and embodiment of the present invention to provide a seasonal light carrier wherein the light holder moves between the first and second positions by sliding.

It is therefore another aspect, advantage, objective and embodiment of the present invention to provide a seasonal light carrier wherein the material of the device is one member selected from the group consisting of: sheet metal, another metal, acrylic, polycarbonate, another polymer, a plurality of co-polymers, plywood, another wood, composites and combinations thereof.

It is therefore another aspect, advantage, objective and embodiment of the present invention to provide a seasonal light carrier further comprising: a handling device dimensioned and configured to allow easy manipulation of the light holder between the first and second positions.

### BRIEF DESCRIPTION OF THE DRAWINGS

FIG. 1 is an end view of the invention in the closed position, with the invention and the lights it carries hidden from public view.

FIG. 2 is an end view of the invention in the open position, with the invention deployed so that the lights carried thereon are visible beneath the fascia board.

FIG. 3 is a perspective rear view of the invention from the mount side, showing the outside of the light holder and the back (fascia side) of the mount.

FIG. 4 is a perspective front view of the invention from the “light” side, showing the inside/front of the light holder and details of the light attachments therein.

### INDEX TO REFERENCE NUMERALS

Fascia Board 10
Fascia Front 12
Fascia Back 14
Light Carrier 20
Screws 22
Mounting 24
Hinge Clamps 26
Hinge Pin 28
Hinge Clips 30
Light Holder 32
Attachments 34
Light Bulb 36
Pull Ring 38

### DETAILED DESCRIPTION

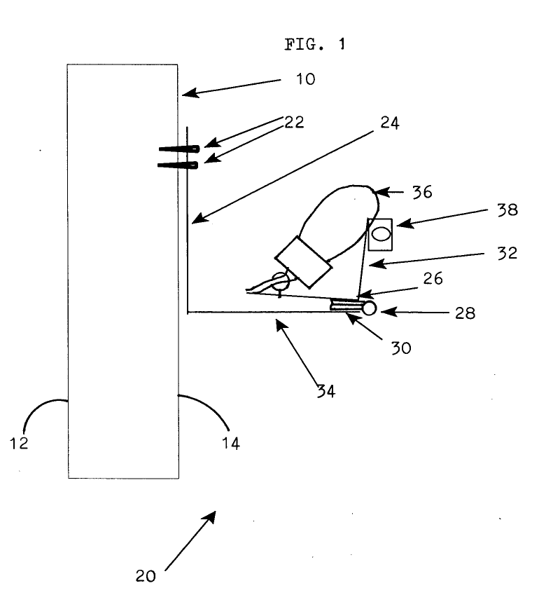

FIG. 1 is an end view of the seasonal light carrier 20 of the invention in the closed position, with the invention and the lights it carries hidden from public view. Fascia board 10 is shown in end view. It is important to understand one key feature of the invention. Fascia front 12 is the portion of the fascia board visible to the public. Fascia back 14 is the portion upon which the invention is actually mounted.

Light carrier 20 is held to fascia back 14 by screws 22, however, it may also be held by nails, studs, bolts, brads, tacks, hooks, adhesive, spikes, and the like. Mounting 24 is affixed to fascia board 10 by screws 22. Regardless of details, mounting 24 is dimensioned and configured so as to physically engage with at least a first portion of a home eave not publically substantially visible, whether by an arm and screws to a fascia back as shown, or by other structures to another structure of the home which is not publically substantially visible.

Mounting 24 being located on fascia back 14 imposes certain structural limitations on the invention. In particular, mounting 24 must itself be dimensioned and configured to physically engage the back of the fascia rather than the front. In addition, as will be discussed later, light holder 32 must be dimensioned and configured to physically conform to the back of the fascia board. In regard to mounting 24, the length of the arm mount's first part (which is secured in direct surface contact with the fascia board 10) may be reduced to allow for limited vertical distance available under the fascia board: the vertical length of the arm's first part may be equal to or less than the space available under the fascia board. Other adaptations may be necessary: the vertical space available may require a longer or shorter second arm part extending perpendicularly from the fascia board. Certain shapes of fascia boards may require that the shape of mount 24 physically conform to the shape of the fascia board.

Hinge clamps 26 hold hinge pin 28, which provides an axis of rotation about which they move. Hinge clips 30 are the “push in” type which may be applied so as to affix the hinge mechanism to the light holder 32 and the mounting 24. Light holder 32 is thus movably attached to the mounting, but in alternative embodiments light holder 32 may not be rotationally connected thereto, but rather may slide on rails, runners, slides, grooves or similar structures, be translationally connected to the mounting 24.

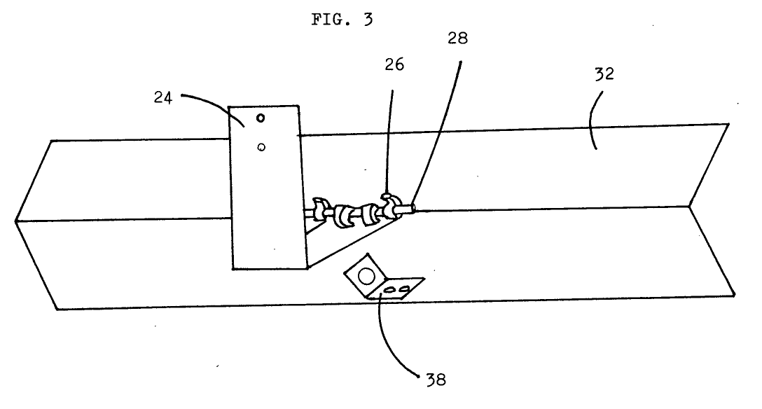

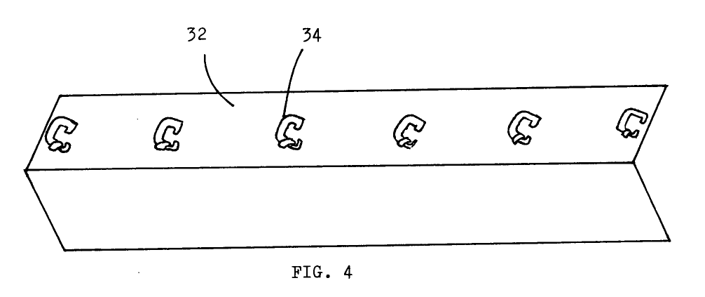

FIG. 3 is a perspective rear view of the invention from the mount side, showing the outside of the light holder and the back (fascia side) of the mount. FIG. 4 is a perspective front view of the invention from the “light” side, showing the inside/front of the light holder and details of the light attachments therein. Attachments 34 are mounted on the inside of the “V” cross sectioned light holder 32. While the “V” cross section is the presently preferred embodiment and best mode presently contemplated for carrying out the invention, other cross sections may be used. For example, the light holder in alternative embodiments may be straight, semi-circular, an “L” cross section and alternatives too numerous to list.

Light bulb 36 is held in place by attachments 34. Seasonal light attachments of the invention are dimensioned and configured to physically engage with at least one portion of such seasonal lights. In practice, C-7 or 7½ or C-9 size light bulbs, mini-lights, LED strings, rope lights and the like are envisioned, but other types of lights may be used. Such lights may be held by attachments 34 along the length of the wires of the light set, as depicted and used in the best mode now contemplated, but this is not a limitation of the invention. Each light itself, or light socket may be held, or other holds may be used.

Pull ring 38 may be advantageously used as a handling device to assist in moving the invention to and from a first position in which the moving light holder, the mounting, the seasonal light attachment, and such seasonal light attached thereto are not publically substantially visible, to and from a second position in which such seasonal light is publically substantially visible. In the presently preferred embodiment, the entire device is not publically substantially visible.

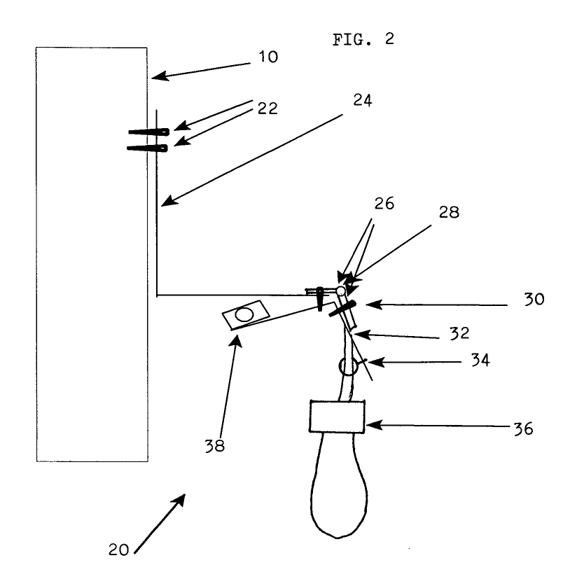

FIG. 2 is an end view of the invention in the open position, with the invention deployed so that the lights carried thereon are visible beneath the fascia board. It will be seen that in the open second position, the lights are suspended so that they are either somewhat or partially below the level of the bottom end of the fascia board, or else are at least now easily publically visible, for example, the lights may actually be above the level of the bottom of the fascia board if public viewing of the house will occur from a reduced angle (such as a house on a hill top or other elevation, a tall house, etc).

It will be appreciated that control of such viewing angles is central to the invention. An item is “publically substantially visible” when it is, for example, visible from ground level of a public thoroughfare, but it is obviously NOT publically substantially visible just because it may be seen when standing directly under the eaves of the house/business/office/structure.

The length of the invention, more particularly the elongated light holder 32, may vary depending upon a number of factors. In most areas rafters of the eaves are on center 14″, 22″ or 30″ apart and span the full depth of the fascia board, it may be necessary to restrict the device to a length slightly smaller than that (for example, lengths in the ranges of 12-13″, 20-21″ or 28-29″) and install one such device between each pair of rafters. However, when the device is used with a fascia board having a more or less continuous back side portion, the device may be considerably longer: for example four feet, six feet, etc. The lengths then may be calibrated to the length of a light set, with cords, for example, a standardized light set might have a length of 12 feet, and thus the invention may be made to be the same length as a seasonal light set (12 feet, in the example), or the same length as only the portion bearing lights, or other similar criteria may be used. Thus the length may be function of light set dimensions, local building ordinance or covenants, and so on.

The potential materials of the invention include sheet metal, galvenized metal, plastics and other polymers, wood, composites and combinations thereof. In the embodiments tested to date, sheet metal is preferred.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the accompanying claims.

1. A seasonal light holder comprising:
a mounting dimensioned and configured so as to physically engage with at least a first portion of a home eave not publically substantially visible,
a light holder movably attached to the mounting,
a seasonal light attachment, the seasonal light attachment dimensioned and configured to physically engage with at least one portion of such seasonal light,
the light holder having a first position in which the moving light holder, the mounting, the seasonal light attachment, and such seasonal light attached thereto are not publically substantially visible, and a second position in which such seasonal light is publically substantially visible.

2. The seasonal light carrier of claim 1, wherein the seasonal light attachment is physically attached to one member selected from the group consisting of the light holder, the mounting, the fascia, another part of the house, and combinations thereof.

3. The seasonal light carrier of claim 1, wherein the mounting comprises an arm having a first part secured to the portion of the home eave not publically substantially visible and having a second part at which the movable attachment of the light holder is located.

4. The seasonal light carrier of claim 1, wherein the movable attachment of the light holder to the mounting comprises one member selected from the group consisting of: hinges, pins, axes, slides, rails, runners, and combinations thereof.

5. The seasonal light carrier of claim 1, wherein the light holder further comprises: a longitudinal member having a “V” shaped cross section.

6. The seasonal light carrier of claim 1, wherein the light holder further comprises: at least one such seasonal light physically engaged to the seasonal light attachment.

7. The seasonal light carrier of claim 1, wherein the seasonal light attachment further comprises a “C” ring having a gap therethrough, wherein the gap is dimensioned and configured to accept the wire of a seasonal light.

8. The seasonal light carrier of claim 1, wherein the light holder moves between the first and second positions by rotating.

9. The seasonal light carrier of claim 1, wherein the light holder moves between the first and second positions by sliding.

10. The seasonal light carrier of claim 1, wherein the material of the device is one member selected from the group consisting of: sheet metal, another metal, acrylic, polycarbonate, another polymer, a plurality of co-polymers, plywood, another wood, composites and combinations thereof.

11. The seasonal light carrier of claim 1, further comprising:
a handling device dimensioned and configured to allow easy manipulation of the light holder between the first and second positions.
